(19) United States
(12) Patent Application Publication
(10) Pub. No.: US 2015/0356912 A1
(43) Pub. Date: Dec. 10, 2015

(54) Hybrid Messaging System

(71) Applicant: Microsoft Corporation, Redmond, WA (US)

(72) Inventor: Paul Dietz, Redmond, WA (US)

(21) Appl. No.: 14/297,703

(22) Filed: Jun. 6, 2014

(51) Int. Cl. G09G 3/32; G06T 13/40; G09F 9/33; G09F 13/22; G09G 3/00; H04N 9/31

(52) U.S. Cl. CPC G09G 3/3208; G09G 3/005; H04N 9/3197; G09F 9/33; G09F 13/22; G06T 13/40

(57) ABSTRACT

Example apparatus provide a messaging and crowd coordination system. An example apparatus may include an optical display that provides first light that encodes first information that is independent of a position from which the first light is viewed. The example apparatus may include an optical projector that projects second light that encodes second information that is dependent on a position from which the second light is viewed. The example apparatus may also include a circuit that coordinates simultaneous presentation of the first light and the second light to produce a hybrid real-time message. The message facilitates coordinating independent actions of members of a plurality of people located at different viewing positions. The independent actions may be selected from a set of actions described by the first information and prescribed by the second information.

### BACKGROUND

Spectators at an event (e.g., football game) are, by definition, spectators. Spectating provides a first type of experience. Participating in an event provides a second, different type of experience. For example, when a fan at a football game participates in a coordinated cheer, the fan may feel more connected to the action. Additionally, a coordinated cheer like the wave may create an entertaining spectacle. Conventionally, it may have been difficult, if even possible at all, to coordinate a large group of people in a sophisticated manner. While a scoreboard may encourage the spectators to perform the wave, the scoreboard may not have an effective method for coordinating the actions of multiple spectators. Difficulties in coordinating groups of people also occur in other environments. For example, a speed limit sign may attempt to inform a group of drivers about the acceptable speed. Additionally, a radar controlled sign may attempt to display the speed for a vehicle. Unfortunately, the speed displayed for one car is visible to all cars and it may be difficult for a driver to know whether the speed displayed is relevant to their car.

Returning to the stadium experience, audience participation may be purposefully designed and encouraged. For example, different colored cards with different numbers may be left on stadium seats for the spectators. At a certain point in time, the stadium scoreboard may display the number of the card that spectators are supposed to hold up. In this way, “stadium art” or “massive human performance art” may be produced. While this type of audience participation has produced interesting and even spectacular results (e.g., Olympic opening ceremonies), the preparation, training, or materials for these displays may be costly, time-consuming, and complex. Additionally, distributing and then disposing of the tens of thousands of colored cards may produce ecological issues. Different approaches for providing group instructions while generating individual action are sought.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

An example apparatus may include a first display that provides a set of non-projection pixels that are viewable from all locations in a viewing space (e.g., stadium, freeway). The example apparatus may also include a massively multi-view (MMV) display that provides a set of projection pixels. In a massively multi-view display, a member of the set of projection pixels may be viewable from less than all the locations in the viewing space or may be individualized (e.g., color selected) for different viewing locations in the viewing space. For example, a member of the set of pixels may be viewable or may be perceived as a certain color from a single seat in a stadium or from a single car-sized space on a freeway. The example apparatus may also include a computer or other circuit that controls an image displayed on the first display and controls projection attributes for the set of projection pixels. The computer synchronizes information displayed on the first display with light projected by members of the set of projection pixels to provide a general message for the viewing space (e.g., speed limit, speeding indicator (e.g., red light, thumbs down), acceptable speed indicator (e.g., green light, thumbs up)) and individual messages for individual locations in the viewing space (e.g., red light, green light, individual car speed). The general message may provide information for how to interpret the individual messages.

In one example, a messaging and crowd coordination system includes an optical display, an optical projector, and a computer. The optical display provides first light that encodes first information. The first information is independent of a position from which the first light is viewed. The optical projector projects second light that encodes second information. The second information is dependent on a position from which the second light is viewed. The computer coordinates simultaneous presentation of the first light and the second light to produce a hybrid real-time message. The hybrid real-time message is used to coordinate independent actions of members of a plurality of people located at different positions. The independent actions may be selected from a set of actions described by the first information and prescribed by the second information.

### BRIEF DESCRIPTION OF THE DRAWINGS

The accompanying drawings illustrate various example apparatus and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example hybrid messaging apparatus.

FIG. 2 illustrates a stadium scoreboard.

FIG. 3 illustrates a stadium scoreboard paired with a massively multi-view apparatus.

FIG. 4 illustrates two scoreboards paired with two massively multi-view apparatus.

FIG. 5 illustrates a scoreboard displaying per volume information and a massively multi-view apparatus projecting per viewing location information.

FIG. 6 illustrates three different embodiments of a hybrid messaging system.

FIG. 7 illustrates an example messaging and crowd coordination system.

FIG. 8 illustrates example hybrid messages.

FIG. 9 illustrates an example hybrid messaging system.

FIG. 10 illustrates five characterizing attributes associated with a ray in a light field.

### DETAILED DESCRIPTION

There are more and more display pixels available in more and more locations every day. Soon, display pixels may be ubiquitous. Conventionally, display pixels may have been operated collectively to provide a single image that was substantially similar from several points of view. For example, the pixels in a television were used to display a television show, the pixels in a highway sign were used to display a traffic message, and the pixels on a stadium scoreboard were used to display images or messages to the people in the stadium. Everyone exposed to the pixels saw substantially the same thing.

“Pixel”, as used herein, refers to the smallest individual element of a presentation. In a flip dot display, “pixel” refers to a single dot that can be flipped. In a displayed but not projected image, “pixel” refers to the smallest element of the display. For example, in an LED display, a single LED would represent a pixel. In a projected image associated with a light field apparatus, “pixel” refers to the ray of light produced by the light field apparatus that is present at a viewing location. In the projected image context, a pixel may be associated with, for example, an individual projector or with a lens associated with a projector.

Example apparatus distinguish between a display and a projector and between light that is displayed and light that is projected. A pixel in a conventional display emits light in many directions over a wide range of solid angles (e.g., 2π steradian). A conventional display may attempt to achieve omnidirectional radiation patterns for a pixel. In contrast, a projector emits light from a pixel over a narrow range of solid angles (e.g., 1 steradian). A projector may attempt to emit controlled light at a single angle in a narrow beam. Light from a displayed pixel may be visible in a large volume (e.g., stadium) while light from a projected pixel may only be visible in a small portion of the volume (e.g., single seat).

The term “projector”, as used herein, may refer to apparatus including, but not limited to, analog film projectors, slide projectors, digital video projectors, light field projectors, or other devices that produce illumination where the color, brightness, temporal pattern, or other projection attribute of the light emitted in different directions or to specific locations can be controlled. A viewing location in a viewing volume where the image is projected perceives the color, brightness, temporal pattern or other projection attribute of the projected pixels that are present at the location. The color and brightness of a projected pixel may be characterized using notations including, but not limited to, the RGB (red, green blue), CMYK (cyan, magenta, yellow, key), HSV (hue, saturation, value(brightness)), HSI (hue, saturation, intensity), and HSL (hue, saturation, lightness) color spaces.

Example apparatus provide a hybrid messaging system where some pixels in an apparatus are used to provide common (e.g., per-audience) information that is visible to all viewers of the pixels while other pixels are used to provide individual (e.g., per viewer) information that may be different for different viewers located in different viewing positions. The hybrid messaging system may display group messages to a viewing space and may simultaneously project individual messages related to the group message to individual viewing locations in the viewing space. Different viewers in different locations may receive different individual messages based on their viewing location. Simultaneously providing a group message that encodes generic contextual information while projecting individualized information to members of the group facilitates providing, for example, a crowd coordination and messaging system.

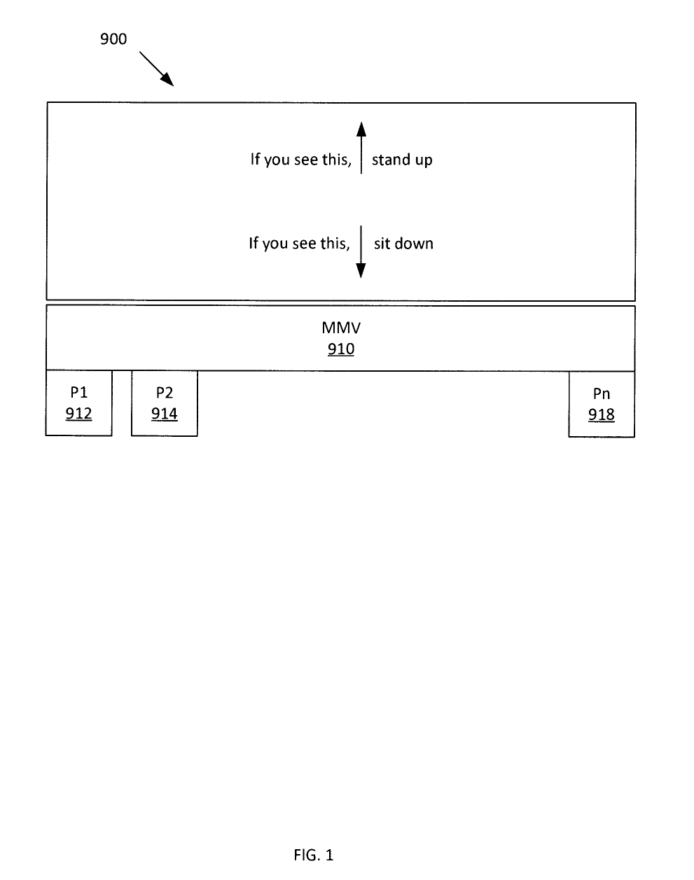

Recall the wave in a stadium, where spectators stand up and sit down based on other spectators standing up and sitting down. Now imagine a scoreboard that provides a general message that identifies a signal for standing up and sitting down, and that also provides, on an individual seat by seat basis, a cue for standing up and sitting down, where each seat may have its own specific cue. See, for example, FIG. 1, which uses a display 900 to provide a general message that identifies that a viewer is supposed to stand up when they see an upward facing arrow and is supposed to sit down when they see a downward facing arrow. MMV 910 may project an upward facing arrow to some seats and may project a downward facing arrow to other seats. For example, a first pixel P1 912 may project an upward facing arrow to a first seat and a second pixel P2 914 may project a downward facing arrow to a second seat. MMV 910 may include a plurality of individually controllable pixels (e.g., P1 912, P2 914 . . . Pn 918) that can each encode a separate message for a separate seat. In this example, different rows in the stadium could be controlled to perform their own wave. Complex geometric shapes (e.g., team logo) could be produced and even “waved” around the stadium. The logo could even be animated. For example, a Seahawk could appear to shriek.

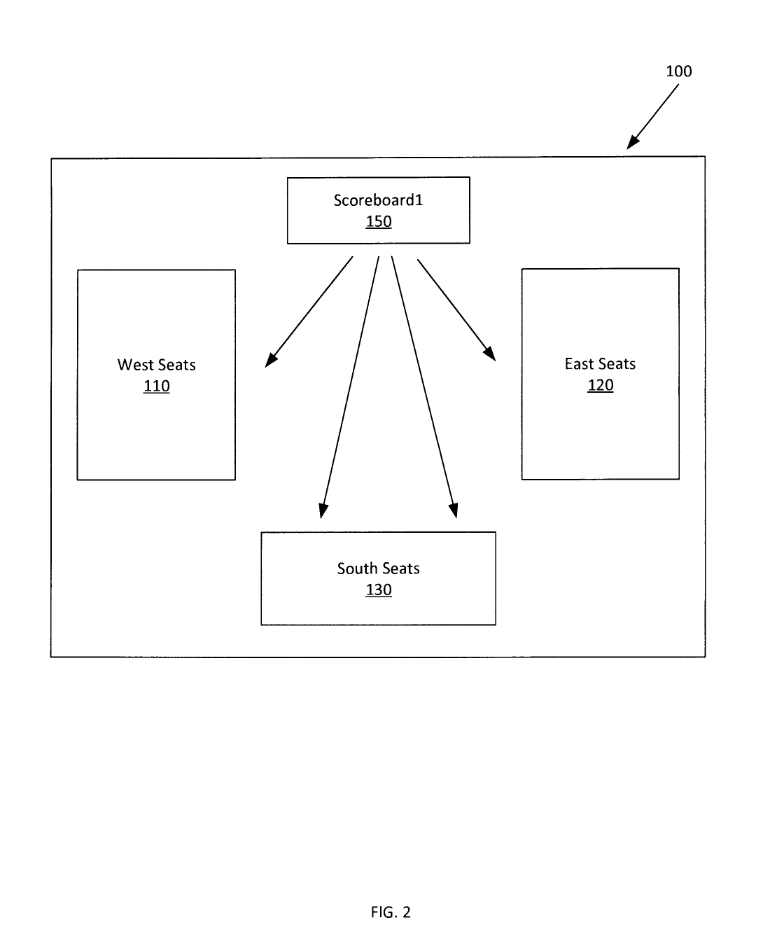

FIG. 2 illustrates a stadium 100 having three different grandstands: the west seats 110, the east seats 120, and the south seats 130. The stadium 100 also includes a scoreboard) 150 that is visible from all of the west seats 110, the east seats 120, and the south seats 130. In this conventional configuration, all the people seated in all the different grandstands may see the same message displayed on the scoreboard.

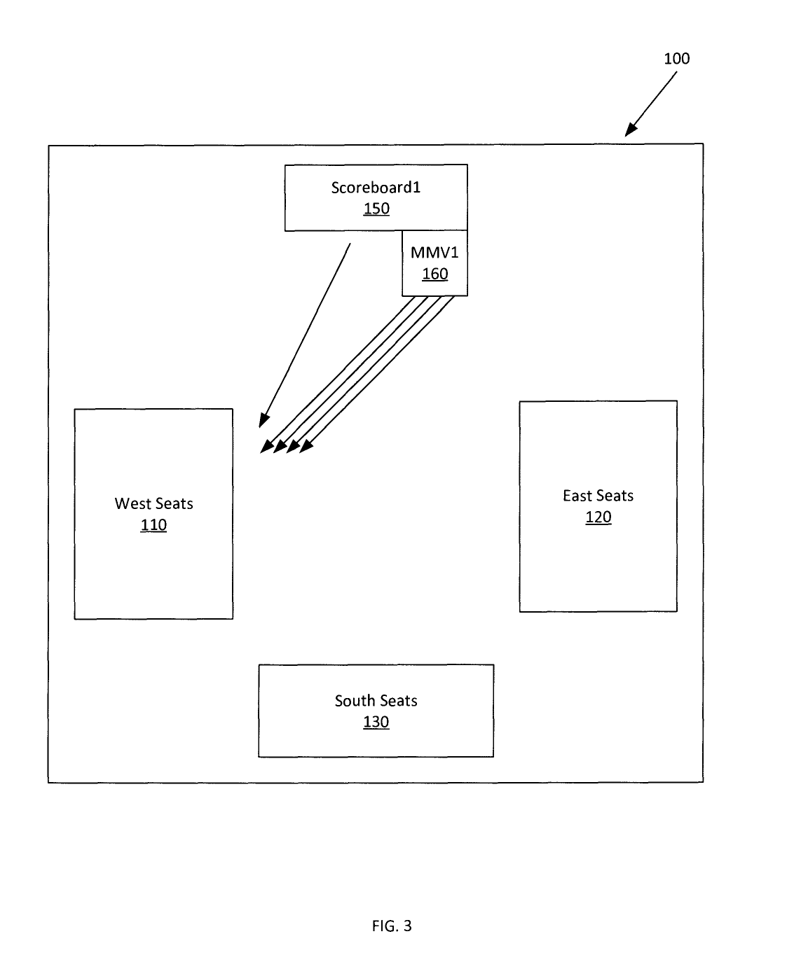

FIG. 3 illustrates a massively multi-view (MMV) apparatus 160 paired with scoreboard1 150. MMV displays allow a single apparatus (e.g., projector, display with lenses) to project different images simultaneously to different locations. To produce an MMV with N pixels (N being an integer), N projectors or lenses may be needed. The cost and complexity for an MMV increases as the number of pixels increases. Thus, it may be desirable to maximize the amount of information presented for a specific purpose while minimizing the number of pixels employed. In a base case, it may be desirable to present useful or actionable information using just a single MMV pixel. To maximize the value of the single MMV pixel, it may be desirable to present additional general information that facilitates understanding and potentially responding to the information provided by (e.g., encoded by) the single MMV pixel. The general information may be presented to multiple (e.g., all) viewing locations in a viewing space while a single MMV pixel may project information to a single location in the viewing space. For example, scoreboard1 150 may display general information for all viewers in stadium 100 while MMV1 160 projects information from individual pixels to individual locations (e.g., seats) in the stadium 100.

An MMV display may use a set of projectors to create individual MMV display pixels that provide different information to viewers in different locations in a viewing volume. While multiple physical projectors are described, virtual projectors may be employed. A virtual projector may be produced by projecting light from an actual projector through a lens array. A virtual projector may be an apparatus that sends controlled pixels to specific regions. When lensing flat panels to make projectors, a diffuser may be employed. Recall that DLP projectors and some other devices may use field sequential color so that each pixel can do a mix a red green or blue. However, on an LCD panel, red green and blue may be spatially distributed. Therefore, when lensing an LCD panel, a diffuser may be employed to avoid gaps between projected pixels.

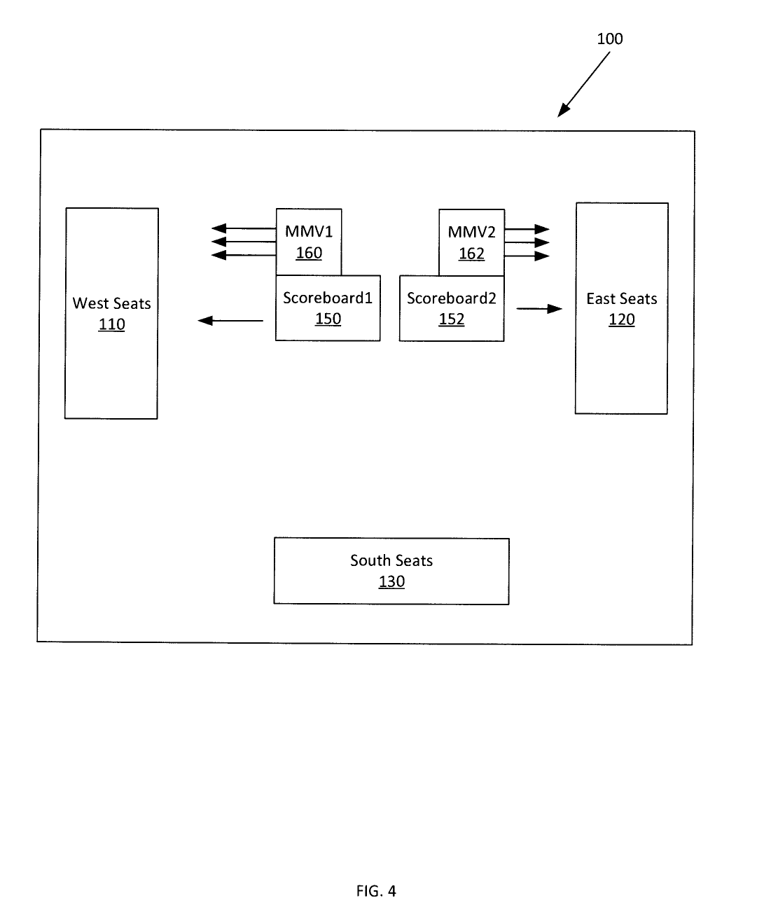

FIG. 4 illustrates stadium 100 reconfigured with two scoreboards (e.g., scoreboard1 150 and scoreboard2 152). A first MMV 160 is paired with scoreboard1 150 and a second MMV 162 is paired with scoreboard2 152. Scoreboard1 150 and MMV1 160 may provide light that is visible in the west seats 110 while scoreboard2 152 and MMV2 162 may provide light that is visible in the east seats 120. No scoreboard and no MMV may be visible to the south seats 130. Thus, the west seats 110 may be referred to as a viewing volume for scoreboard) 150 and MMV1 160 while the east seats 120 may be referred to as a viewing volume for scoreboard2 152 and MMV2 162. The south seats 130 are not in the viewing volumes for the west seats 110 or the east seats 120.

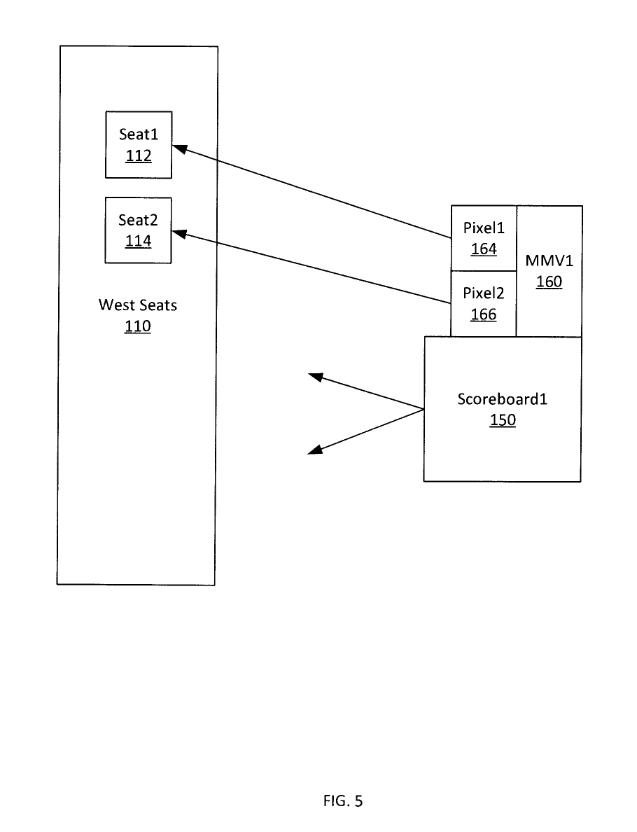

FIG. 5 illustrates MMV1 160 projecting light from pixel1 164 to seat1 112 and from pixel2 166 to seat2 114. Scoreboard1 150 is displaying light to the entire viewing volume associated with the west seats 110. MMV1 160 is projecting light associated with individual pixels to individual locations in the viewing volume associated with the west seats 110. The light projected from pixel1 164 is visible at seat1 112 but is not visible at seat2 114. The light projected from pixel2 166 is visible at seat2 114 but is not visible at seat1 112. Thus, the scoreboard1 150 may provide general information that identifies how to respond to an individual message that may be encoded in, for example, the light projected by pixel1 164 or the light projected by pixel2 166.

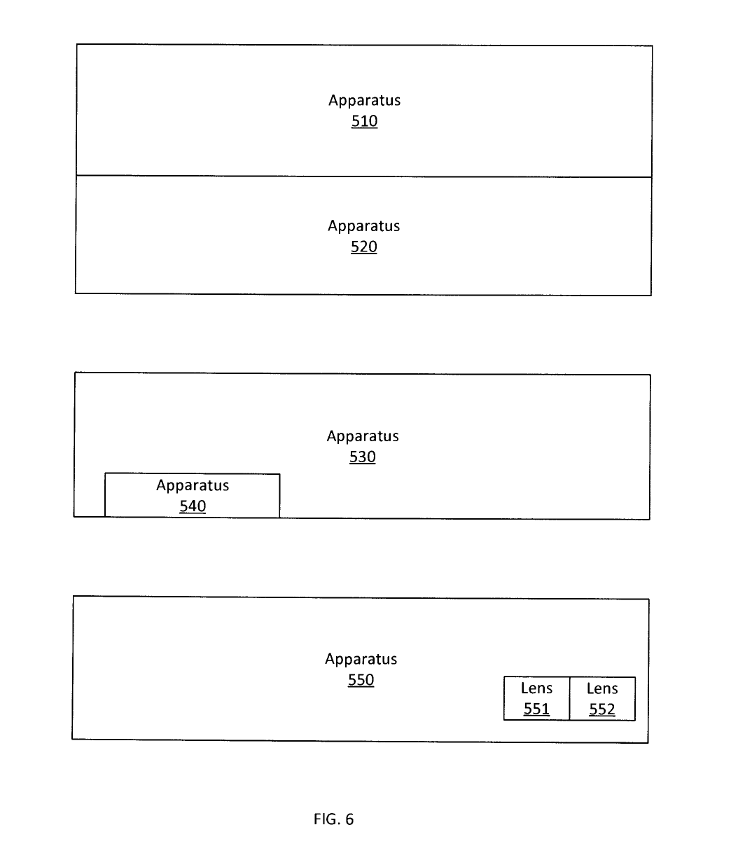

FIG. 6 illustrates three different embodiments of a hybrid messaging system. An apparatus 510 (e.g., conventional display) and an apparatus 520 (e.g., MMV projector) may be positioned together to produce a hybrid messaging system. In this embodiment, apparatus 520 does not occlude apparatus 510. An apparatus 540 may be positioned in front of apparatus 530 to produce a hybrid messaging system. In this configuration, apparatus 540 may occlude part of apparatus 530. An apparatus 550 may be converted to a hybrid messaging apparatus by including, for example, lens 551 and lens 552. The portions of apparatus 550 that do not interact with the lenses may simply display information while the portions of apparatus 550 that do interact with the lenses may project information. The displayed information may be used to provide a general audience message while the projected information may be used to provide a per viewer message.

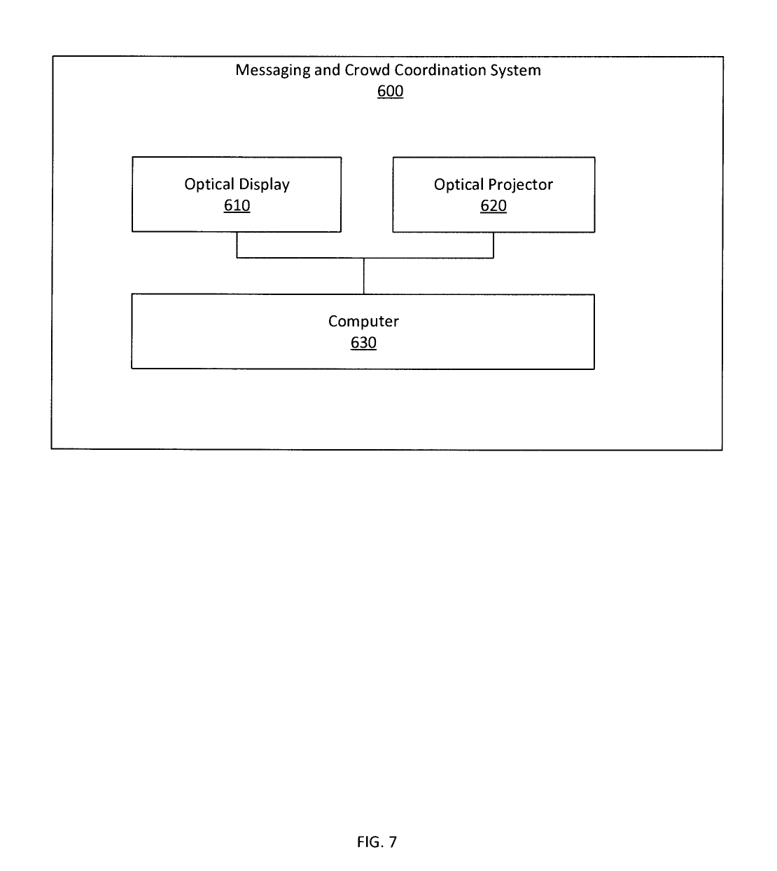

FIG. 7 illustrates a messaging and crowd coordination system 600. System 600 includes an optical display 610 that provides first light that encodes first information. System 600 also includes an optical projector 620 that projects second light that encodes second information. System 600 also includes a computer 630 that coordinates simultaneous presentation of the first light and the second light to produce a hybrid real-time message. The real-time message facilitates, for example, coordinating independent actions of members of a plurality of people located at different positions. The independent actions may be selected from a set of actions described by the first information and prescribed by the second information. The first information is independent of a position from which the first light is viewed. The second information is dependent on a position from which the second light is viewed. For example, the first information may appear the same to all spectators in an arena but the second information may appear different to different members of the arena.

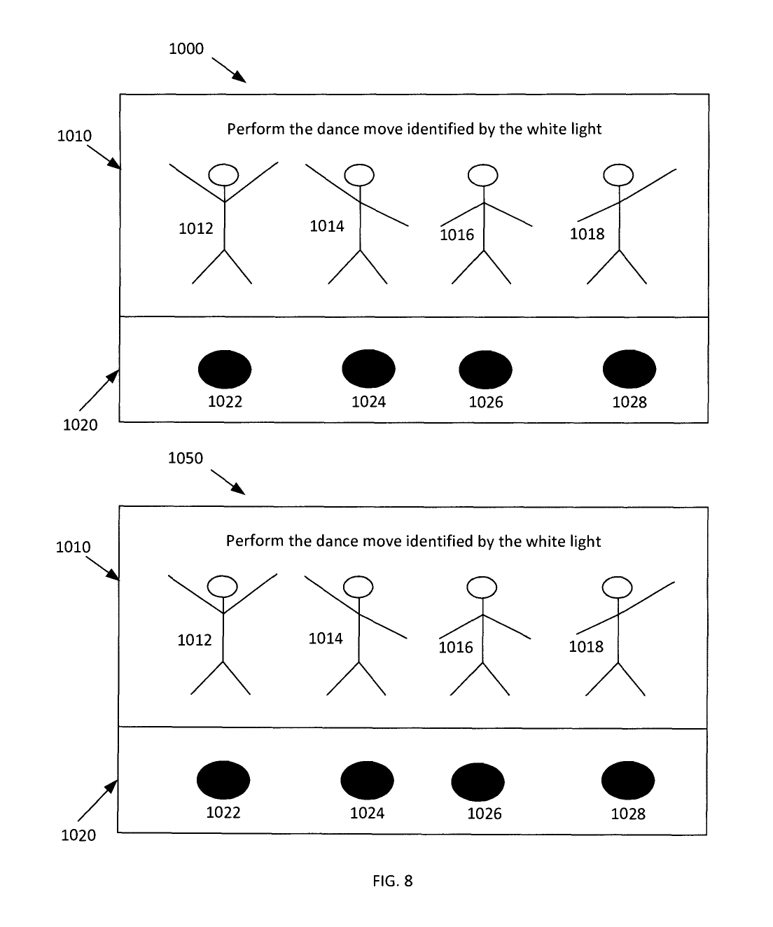

By way of illustration, consider the two views 1000 and 1050 provided in FIG. 8. View 1000 represents what a viewer in a first location may see when they look at a messaging system. View 1050 represents what a viewer in a second location may see when they look at the same messaging system at the same time. Both viewers would see the four dance moves illustrated by a first optical display 1010. However, the two viewers would see different “lights” projected from a second optical apparatus 1020. Thus, the first viewer might perform the dance move associated with light 1026 while the second viewer might perform the dance move associated with light 1024. Other viewers at other locations may perform dance moves associated with lights 1022 and 1028.

In one embodiment, a single optical projector projects pixels into a viewing volume. An observer of the projector from a first location in the viewing volume will see the brightness and color of the pixels that are projected to the first location and an observer of the projector from a second location in the viewing volume will see the brightness and color of the pixels that are projected to the second location. The brightness and color of the pixels may be individually controlled for individual viewing locations in the viewing volume. Different messages (e.g., sit, stand, slow down, move this way) may be encoded by controlling pixel parameters (e.g., brightness, color, temporal pattern).

While a single optical projector projecting pixels into the volume is described, in different embodiments, a greater number of optical projectors may be employed. In one embodiment, a single optical projector projects light of a prescribed color, brightness, or pattern towards a viewing location in the viewing volume. In another embodiment, two or more optical projectors project light of a prescribed color, brightness, or pattern towards a viewing location in the viewing volume. The light represents the information to be conveyed to a viewer at the viewing location. The light projected to a first viewing location may be different than the light projected to a second viewing location. A display visible to multiple viewing locations or even the entire viewing space may simultaneously provide information that may provide context or instructions for understanding the light projected to the individual viewing locations.

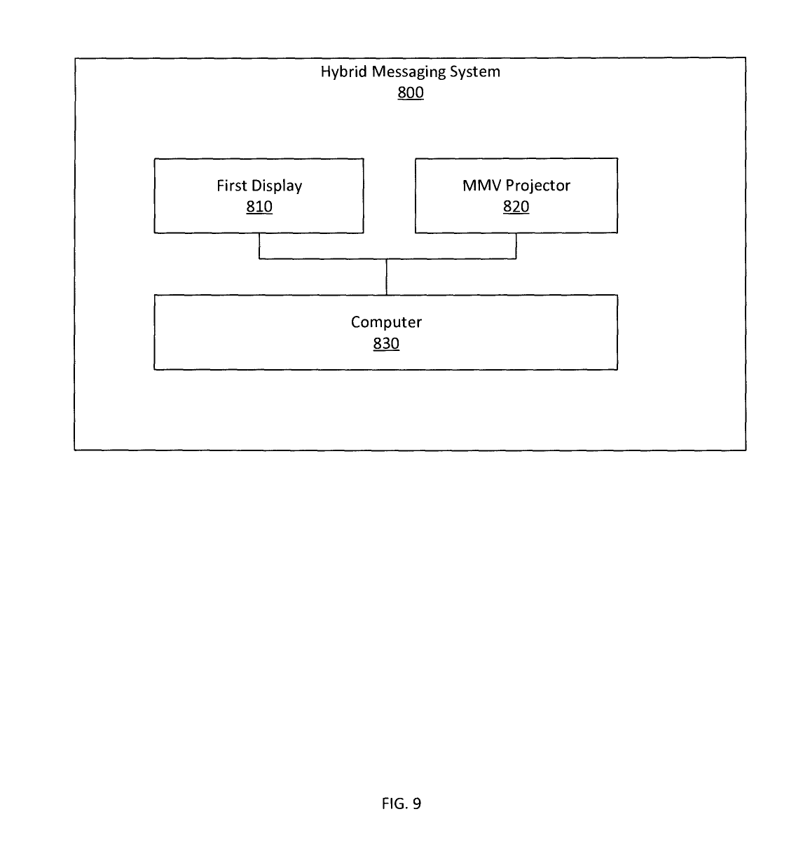

FIG. 9 illustrates a hybrid messaging system 800. Hybrid messaging system 800 includes a display 810 that provides a set of non-projection pixels that are viewable from all locations in a viewing space. Hybrid messaging system 800 also includes a massively multi-view (MMV) projector 820 that provides a set of projection pixels. A member of the set of projection pixels may be viewable from less than all locations in the viewing space or may be individualized (e.g., color, pattern) for different viewing locations. Hybrid messaging system 800 also includes a circuit or computer 830 that controls an image displayed on the display 810 and that controls projection attributes for the set of projection pixels projected by the MMV projector 820. The computer 830 synchronizes information displayed on the display 810 with light projected by members of the set of projection pixels by the MMV projector 820 to provide a general message for the viewing space and to provide individual messages for individual locations in the viewing space. The general message may provide information for how to interpret the individual messages.

The display 810 may take different forms. In one embodiment, the display 810 may be a static display like a billboard or traffic sign. In another embodiment, the display 810 may be a projected display, a light emitting diode (LED) display, or an organic light emitting diode (OLED) display. In another embodiment, the display 810 may even be a mechanical display (e.g., flip dot display). Display 810 displays information that is viewable from multiple locations in a viewing volume. The information displayed by the first display 810 is the same information at all viewing locations.

The MMV projector 820 may also take different forms. In one embodiment, the MMV projector 820 may provide the set of projection pixels using one or more projectors. In another embodiment, the MMV projector 820 may provide the set of projection pixels using one or more lenses. Different combinations of projectors and lenses may be employed. In one embodiment, the MMV projector 820 may be dynamically reconfigurable. For example, the MMV projector 820 may be controlled to selectively provide less than one pixel per viewing location in the viewing space, to provide one pixel per viewing location in the viewing space, or to provide two or more pixels per viewing location in the viewing space.

While FIG. 9 illustrated a hybrid messaging system 800 having a display 810 that provides a set of non-projection pixels, a massively multi-view (MMV) projector 820 that provides a set of projection pixels, and a computer 830 to coordinate information presented by the two displays, example apparatus may be more generally described. In one embodiment, apparatus 800 may not include an onboard computer, but may be controlled by or coupled to an external computer or circuit.

An apparatus may have a first apparatus that displays per-volume information to a volume having a plurality of viewing locations and may have a second apparatus that projects per-viewing-location information to two or more members of the plurality of viewing locations. The apparatus may provide the per-volume information and the per-viewing-location information simultaneously so that they may be detected simultaneously from the same viewing location in the volume. In one embodiment, the per-volume information provides information related to the per-viewing-location information. In another embodiment, the per-volume information provides context for understanding the per-viewing-location information. In yet another embodiment, the per-volume information presents instructions for performing actions identified by the per-viewing-location information or information for decoding the per-viewing-location information.

The per-viewing-location information may include first per-viewing-location information that is projected to a first subset of the plurality of viewing locations and may also include second, different per-viewing-location information that is projected to a second, disjoint subset of the plurality of viewing locations. For example, the first per-viewing-location information may be projected to a first seat in a stadium or to a first car on a freeway and the second per-viewing-location information may be projected to a second different seat in the stadium or to a second different car on the freeway. The first per-viewing-location information is visible at the first subset (e.g., first seat, first car) and is not visible at the second subset (e.g., second seat, second car). Additionally, the second per-viewing-location information is visible at the second subset and is not visible at the first subset.

The first per-viewing-location information and the second per-viewing-location information are projected simultaneously but are individually controllable with respect to one or more projection attributes. Being individually controllable allows different information to be encoded in the simultaneously displayed first per-viewing-location information and the second per-viewing-location information. Since the per-volume information and per-viewing-location information may be intended to cause coordinated actions, the per-viewing-location information that is selected to be projected to a selected viewing location may be selected as a function of the position of the viewing location. For example, when coordinating “the wave” at a stadium, the information provided in the per-viewing-location information will change as the wave washes around the stadium. Thus, the per-viewing-location information projected to a location (e.g., seat) will be selected to cause the viewer to stand up or sit down at the appropriate time to achieve the wave effect.

While standing and sitting are described, more generally the per-volume information may describe a set of actions to be selectively performed by a viewer in the volume and the per-viewing-location information indicates a member of the set of actions to be performed.

In one embodiment, the per-volume information is a movement instruction (e.g., leave the building, exit the freeway) and the per-viewing-location information describes a direction in which a viewer at a specific viewing location in the volume is to move. For example, in an arena, after a fire alarm has been activated, a first apparatus (e.g., the arena scoreboard) may display a general message (e.g., move towards the indicated exit NOW) while a second apparatus (e.g., MMV attached to scoreboard) may display second information (e.g., an arrow pointing out the direction in which a person at a specific location should move to get to the exit most efficiently).

In one embodiment, the per-volume information is speed limit information and the per-viewing-location information describes whether a vehicle at a specific viewing location in the volume is complying with the speed limit. For example, a traffic sign may have a first apparatus (e.g., set of light bulbs) that display the current speed limit and may have a second apparatus (e.g., MMV) that projects a “slow down” (e.g., red light, thumbs down) indicator or a “you're okay” (e.g., green light, thumbs up) indicator. Many cars on the freeway may see the speed limit displayed by the light bulbs, but different specific cars will see the projected information specific to that car.

In one embodiment, the entire apparatus may be a light field apparatus. In other embodiments, just the second apparatus may be a light field apparatus. In different embodiments the first apparatus may be a television or a computer monitor. In different embodiments the second apparatus may be a projector or a light field projector. In one embodiment, the second apparatus may be a non-projecting display that is modified to operate as a projector by the addition of a lens. For example, the second apparatus may be a flat panel light emitting diode (LED) display that is modified to operate as a plurality of projectors by the addition of a lens array. Different combinations of displays and projectors may be employed.

A light field may be described by a function that identifies the amount of light travelling in every direction in every point in space. Arun Gershun defined the light field as radiance as a function of position and direction in regions of space. A. Gershun, “The Light Field,” Moscow, 1936, trans. by P. Moon and G. Timoshenko, J. Math. and Physics, vol. 18, 1939, pp. 51-151. Gershun considered the light passing through a point to be a sum of vectors, with one vector per direction influencing the point. The lengths of the vectors were proportional to their radiance. Integrating these vectors over the sphere of incoming directions produces a scalar value that represents the total radiance at that point and in a resultant direction.

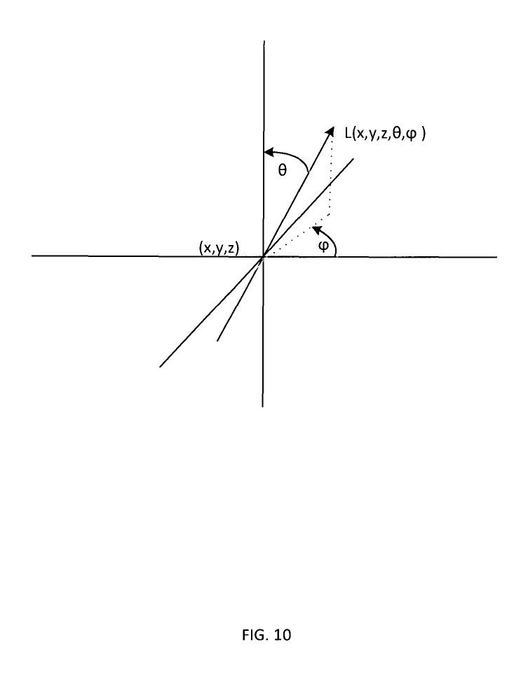

In geometrical optics involving spatially incoherent illumination of objects significantly larger than the wavelength of light, rays are the fundamental carrier of light. The amount of light travelling along a ray is radiance (L), which is measured in watts (W) per steradian (sr) per meter squared (m²). The radiance along all of a set of rays in a region of three dimensional space illuminated by an unchanging arrangement of lights is referred to as the plenoptic function. Rays in space may be described using five measures (x, y, z, θ, φ) (see, e.g., FIG. 10). Thus, the plenoptic function that is used in association with light fields is a five dimensional function. In certain circumstances, the radiance along a ray remains constant and thus the five dimensional space may be reduced to a four dimensional space, which may be referred to as photic field, or a 4D light field. For a planar light field, z is constant, which allows creation of the desired 4D light field using a two dimensional array of two dimensional projectors.

Research that has been done in light field projection has tended toward improving light field projectors that include multiple projectors that attempt to reproduce a meaningful, understandable representation of a light field for a single viewer at a single point in space or for a single viewer in a volume. More simply, conventional research appears to be focused on reproducing the light field for a viewer.

Example light field projectors employed by example apparatus address a different situation. Some example light field projectors seek to produce a single piece of information for a single viewer at a single location in a volume while simultaneously producing a different single piece of information for a different single viewer at a different single location in the volume. Thus, example apparatus may include a smaller number of projectors that produce different displays for different viewers at different points in space.

In one embodiment, light incident on a given point in the viewing volume receives rays originating from a single pixel in a single projector. In another embodiment, light incident on a given point in the viewing volume receives rays originating from two or more pixels in a single projector. Different embodiments may also employ lenses or lens arrays.

While projectors have been described, “virtual projectors” may be produced using a lens array. Lens array optics having multiple lenses may split the image projected from an actual optical projector so that a different portion of the image is projected to different viewing locations. In a single-projector embodiment, the apparent effect of multiple projectors can be simulated using a lens array. In multiple-projector implementations, the number of projectors employed can be reduced by using lens arrays.

Lens array optics or other appropriate optics may be used to split the image from a projector so that a portion of the image is projected from different lenses of the lens array. For a hybrid projector-based crowd coordination and messaging system, a lens in a lens array may be treated as if the light projected through the lens is light projected from a separate virtual projector. Even though a limited number of the available projector pixels may be projected from a lens in a lens array, the limited number may be still large enough so that at least one of the projected pixels can be seen from a viewing location in the viewing volume. Since the number (e.g., 10⁶) of projector pixels in a projector may exceed the number (e.g., 10⁵) of viewing locations (e.g., seats) in even the largest viewing volumes (e.g., outdoor soccer stadium), in one embodiment, every person in an audience may be presented with light from a different pixel when looking at an example lens array. In one embodiment, lens array optics are employed with a single projector so that a different portion of the projector image is projected onto the viewing locations by different lenses. This embodiment simulates a multiple-projector embodiment.

In one embodiment, a flat panel display designed for direct viewing may be used as a digital optical projector. The flat panel display can be adapted to create a projector array by positioning a lens array or other appropriate optics appropriately (e.g., in front) with respect to the flat panel display. In this embodiment, the image projected by a lens in the lens array may be the image formed by the pixels of the flat panel display behind the lens.

Thus, in one embodiment, the first per-viewing-location information may be provided by a first pixel provided by a first projector. In another embodiment, the second per-viewing-location information may be provided by a second pixel provided by the first projector. In yet another embodiment, the second per-viewing-location information may be provided by a second pixel provided by a second projector. Different numbers and collections of projectors and lenses may be employed to provide the per-viewing-location information.

Example apparatus may be employed, for example, in identity and location based targeting advertising and shopping. By way of illustration, a facial recognition system could identify a person currently within viewing distance of a hybrid messaging system. A discount code may be provided in the per-volume information and specific product information tailored for the identified person may could be projected to their location.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a first apparatus that displays per-volume information to a volume having a plurality of viewing locations, and
a second apparatus that projects per-viewing-location information to two or more members of the plurality of viewing locations,
where the per-volume information and the per-viewing-location information are provided simultaneously and may be detected simultaneously from the same viewing location,
where the per-volume information provides information related to the per-viewing-location information,
where the per-viewing-location information includes first per-viewing-location information that is projected to a first subset of the plurality of viewing locations and second different per-viewing-location information that is projected to a second disjoint subset of the plurality of viewing locations, where the first per-viewing-location information is visible at the first subset and is not visible at the second subset, where the second per-viewing-location information is visible at the second subset and is not visible at the first subset, where the first per-viewing-location information and the second per-viewing-location information are projected simultaneously, and where the first per-viewing-location information and the second per-viewing-location information are individually controllable with respect to one or more projection attributes, and
where the per-viewing-location information that is projected to a selected viewing location in the plurality of viewing locations is selected as a function of the position of the viewing location.

2. The apparatus of claim 1, where the per-volume information describes a set of actions to be selectively performed by a viewer in the volume and where the per-viewing-location information indicates a member of the set of actions to be performed.

3. The apparatus of claim 1, where the per-volume information is a movement instruction and where the per-viewing-location information describes a direction in which a viewer at a specific viewing location in the volume is to move.

4. The apparatus of claim 1, where the per-volume information is speed limit information and where the per-viewing-location information describes whether a vehicle at a specific viewing location in the volume is complying with the speed limit.

5. The apparatus of claim 1, where the one or more projection attributes include color, brightness, and temporal pattern.

6. The apparatus of claim 1, the first apparatus being a projector, a light field projector, a television, or a computer monitor.

7. The apparatus of claim 1, the second apparatus being a projector or a light field projector.

8. The apparatus of claim 1, the second apparatus being a non-projecting display that is modified to operate as a projector by the addition of a lens.

9. The apparatus of claim 1, the second apparatus being a flat panel light emitting diode (LED) display that is modified to operate as a plurality of projectors by the addition of a lens array.

10. The apparatus of claim 1, where the first per-viewing-location information is provided by a first pixel provided by a first projector.

11. The apparatus of claim 10, where the second per-viewing-location information is provided by a second pixel provided by the first projector.

12. The apparatus of claim 10, where the second per-viewing-location information is provided by a second pixel provided by a second projector.

13. The apparatus of claim 1, where the per-volume information provides a purchase code and where the per-viewing-location information describes an item to purchase.

14. The apparatus of claim 1, where the apparatus is a scoreboard or highway sign that measures at least ten feet by ten feet, and where the second apparatus measures less than one foot by one foot.

15. A hybrid messaging system, comprising:
a first display that provides a set of non-projection pixels that are viewable from all locations in a viewing space;
a massively multi-view (MMV) projector that provides a set of projection pixels, where a member of the set of projection pixels is viewable from less than all locations in the viewing space, and
a computer that controls an image displayed on the first display and that controls projection attributes for the set of projection pixels, where the computer synchronizes information displayed on the first display with light projected by members of the set of projection pixels to provide a general message for the viewing space and to provide individual messages for individual locations in the viewing space, where the general message provides information related to the individual messages.

16. The hybrid messaging system of claim 15, where the first display is a static display, a light emitting diode (LED) display, an organic light emitting diode (OLED) display, or a flip dot display.

17. The hybrid messaging system of claim 15, where the MMV projector provides the set of projection pixels using one or more projectors.

18. The hybrid messaging system of claim 15, where the MMV projector provides the set of projection pixels using one or more lenses.

19. The hybrid messaging system of claim 15, where the MMV projector selectively provides: less than one pixel per viewing location in the viewing space, one pixel per viewing location in the viewing space, or two or more pixels per viewing location in the viewing space.

20. A messaging and crowd coordination system, comprising:
an optical display that provides first light that encodes first information, where the first information is independent of a position from which the first light is viewed;
an optical projector that projects second light that encodes second information, where the second information is dependent on a position from which the second light is viewed, and
a circuit that coordinates simultaneous presentation of the first light and the second light to produce a hybrid real-time message for coordinating independent actions of members of a plurality of people located at different positions, where the independent actions are selected from a set of actions described by the first information and prescribed by the second information.
